(19) United States
(12) Patent Application Publication
(10) Pub. No.: US 2014/0115722 A1
(43) Pub. Date: Apr. 24, 2014

(54) User Generated Content Distribution

(71) Applicants: Alex J. Cohen, Mill Valley, CA (US); William Randolph Hearst, III, San Francisco, CA (US)

(72) Inventors: Alex J. Cohen, Mill Valley, CA (US); William Randolph Hearst, III, San Francisco, CA (US)

(21) Appl. No.: 13/839,474

(22) Filed: Mar. 15, 2013

Related U.S. Application Data
(63) Continuation of application No. 11/400,045, filed on Apr. 5, 2006.
(60) Provisional application No. 60/668,677, filed on Apr. 5, 2005.

(51) Int. Cl. H04L 29/06

(52) U.S. Cl. CPC H04L 63/10
USPC 726/28

(57) ABSTRACT

Methods, apparatuses, and systems facilitating search, discovery, submission and/or distribution of digital objects over networks. In one implementation, the system allows users to search, discover, and/or submit a digitally encoded multi-media object in any number of different formats and direct that content to any device or devices.

### CROSS-REFERENCE TO RELATED APPLICATION

The present application is a continuation of and claims priority to Ser. No. 11/400,045 filed Apr. 5, 2006, which in turn claims priority to U.S. Provisional Application Ser. No. 60/668,677 filed Apr. 5, 2005.

### FIELD OF THE INVENTION

The present invention relates to multi-media content and, more particularly, to methods, apparatuses and systems facilitating search, submission and/or distribution of digital multimedia content across multiple devices and environments with differing capabilities. In one implementation, the present invention relates to electronic transmission of media and a system for multi-media discovery, distribution, and submission.

### BACKGROUND

Unlike physical objects, digital objects are readily copied and transformed. The Internet has added another dimension to digital objects, in that it provides discoverability, distribution and delivery mechanisms. In order to view a movie, listen to song, play a game, or download a multimedia file or digital object, a user will search for that content on the World Wide Web in order to learn more about it, see what others have said about it, find related content, among a myriad of other potential actions. Much of the media, however, which might be found and viewed, purchased for viewing, or downloaded is not appropriate for the user's current device, here generally speaking an ‘environment.’ For example, a desired media object may be embodied in an incompatible format, such as the wrong codec. Alternatively, the current environment where the user has discovered the object may be inappropriate or undesirable given, for example, the duration or resolution of the media object. Even if a media object is appropriate for the environment in which it was first discovered, the user might really prefer to play the content found on the Internet on a home TV set, an MP3 player, in a car, on a personal video recorder, a PDA, or any of a myriad of devices.

Thus it can be appreciated that a need in the art exists for a multi-media content distribution system, which could redirect (and optionally perform one or more additional operations on) identified content to the appropriate device. For example, a user might find a movie on one web site, but desire playing it on a television that evening. The user might wish to download a song to a personal computer (PC), but also have it available in the car, on a portable MP3 player, and/or on a home MP3 enabled stereo system. In addition, a user might find a video news clip on a laptop using a web browser and wish to view it later on a cellular phone, or visa versa. Similarly, a user may wish to send that content or otherwise make it available to any number of friends, all of whom might need to play the content on any number of different devices, all of which may have different encoding methods, aspect ratios, bit rate capacity, and so on. Such a system would not be limited to videos or audio files, but would be similarly useful in the case of other files such as presentations, or even other applications such as computer games. Embodiments of the invention substantially fulfill these needs.

### SUMMARY

The present invention provides methods, apparatuses, and systems facilitating search, discovery, submission and/or distribution of digital objects over a network. In one implementation, the system allows users to search, discover, and/or submit a digitally encoded multi-media object in any number of different formats and direct that content to any device or devices they wish to play, listen, record or view it on. The system, in one implementation, provides a means of managing the discovery, but, in some implementations, also the purchasing and licensing of multimedia content. The system provides for searching directly on the multimedia distribution system, whereby a user can search an index or browse through categories of content and choose a media object and watch it directly within the current environment in which he is accessing the multimedia distribution system (e.g., a PC, PDA, cell phone, etc.). Alternatively, the media distribution system allows the user to redirect the object to one or a plurality of other devices. For example, a desired digital object can be downloaded and transcoded on a server for redirection to the current device, or for redirection to one or a plurality of other devices. In other implementations, a target device can be remotely configured to record a stream or download the object.

In addition to indexed material, if the user has provided information as to whether he or she has cable television or satellite or broadcast video, radio or other any method of streaming delivery, and has provided a location or a list of locations where their devices are, or may be, or where they are based on zip code or city and country information, then the media distribution system also searches various content information available from electronic program guides, movie listings, radio listings and so on, such that the system can indicate to the user whether and when the content for which he or she was searching is available via any such systems either for direct viewing or listening from the stream or in a local movie or event listing. In some embodiments, the user need only present a telephone number or some other unique identifier or some other indicator to link a media distribution environment with another device, for example a cable box, personal video recorder, PC among others.

Additionally, the media distribution system can be configured to manage the publishing of content through a plurality of means such as HTTP spidering the content from the world wide web via accessing HTML, and embellished HTML such as various forms of XML, via a web services interface, RSS (Really Simple Syndication) and RSS 2.0 (with enclosures with URIs pointing to the content for download), as well as manually publishing to a media distribution system database via a web based User Interface (UI), or an application or UI on a device. Furthermore, it can be appreciated that many times the content which is available is not in the appropriate format for playing on the devices which the user might have available and have registered with the present system. In that case the media distribution system may, in one embodiment, transcode the media into the appropriate format, as for example a windows media file into a QuickTime file in the case of a video.

In sum, the functionality available to the user through the web interface, in one embodiment, would provide browsing through hierarchical categories, searching for content via full-text search of metadata, viewing the metadata, selecting content for immediate viewing, download, or redirection to another media device or location or add to a queue for later delivery. The system can determine and display that the current environment is capable of responding appropriately, for example, playing a digital video, it is capable of determining and displaying that the user typically prefers such content downloaded later to a network connected digital video playback device located at their large-screen TV. The interface can show that a device can be controlled, and provide controls for that device to record a stream at the appropriate time or show commands that will be sent to that device. The interface can show a list of the content downloaded to various devices, and provide a means to delete or archive content already download to the device. In the case of other devices, the interface would if capable, allow the initiation of a download or record operation for that device or another, show content available on other devices, delete content, archive content.

In all or some of the above cases, the media distribution system, according to some implementations of the invention, provides a method for either transcoding the object discovered for the user's current environment, and/or redirecting it to an environment suited to its use, or otherwise facilitating the download, transmission or recording of the object either in the present environment or another. Additionally, in one implementation, the methods and system herein described facilitate purchasing or authorizing the obtaining of the media object, depending on a variety of circumstances.

### DESCRIPTION OF THE DRAWINGS

FIG. 1 is a functional block diagram setting forth a high-level system architecture according to one implementation of the present invention.

FIG. 2 is a functional block diagram illustrating operation of one implementation of the present invention across a computer network.

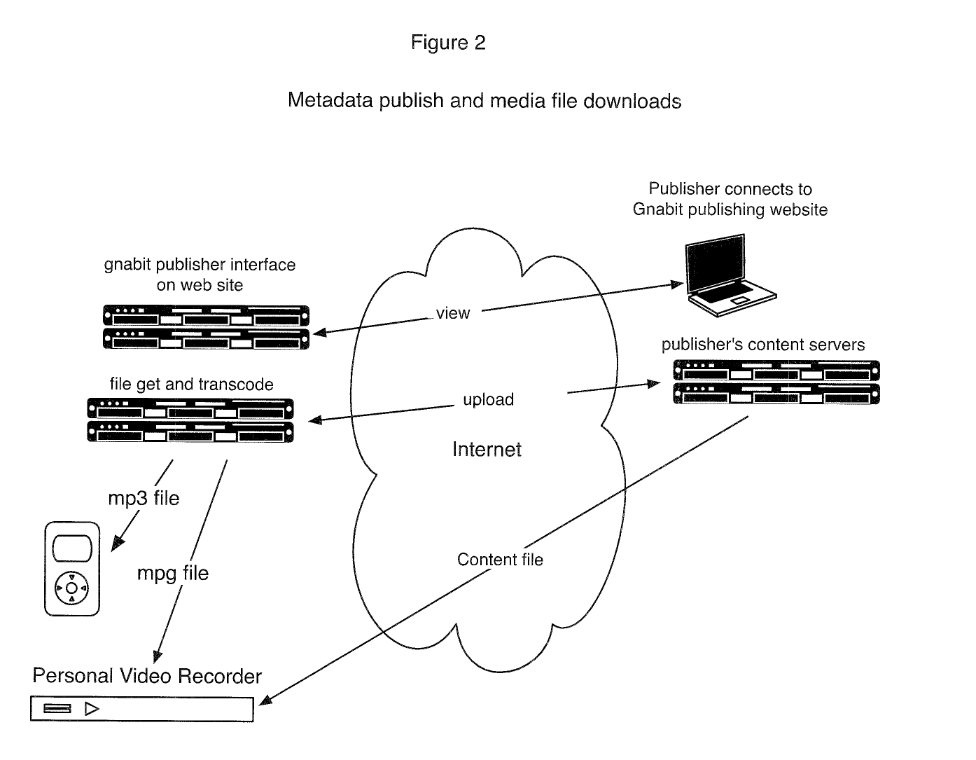

FIG. 3 is a functional block diagram illustrating a high-level, proxy-based system architecture according to another implementation of the present invention.

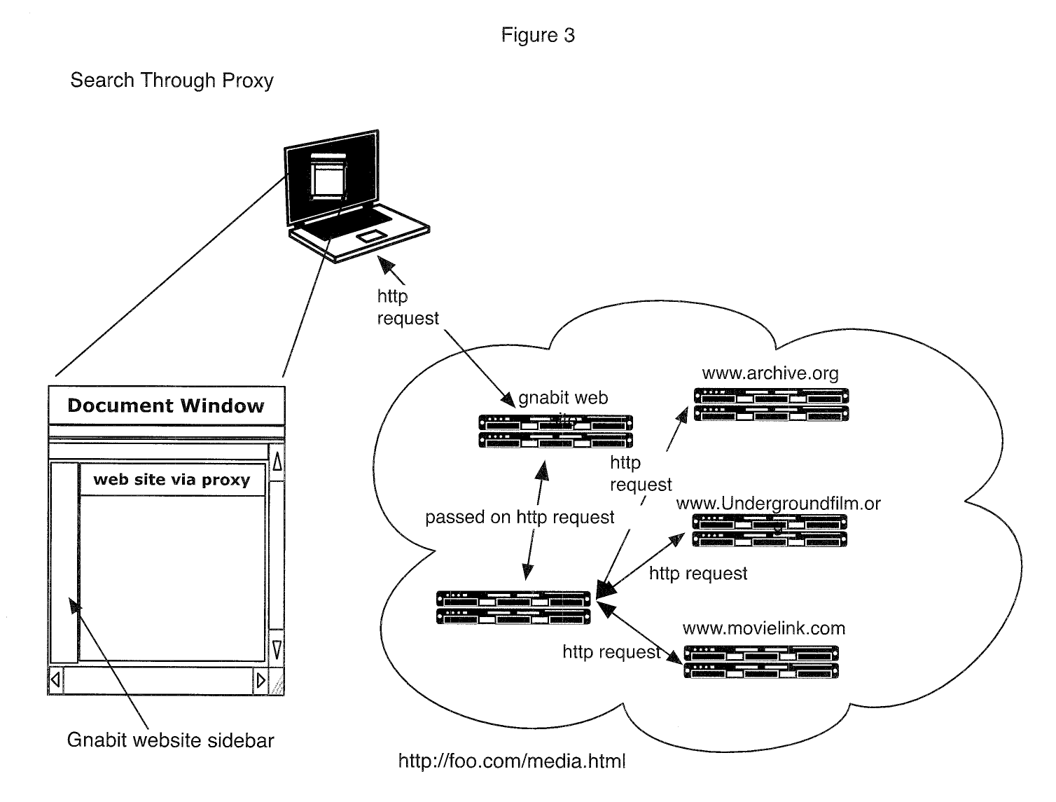

FIG. 4 is a functional block diagram illustrating distribution of content to one or more user devices.

FIG. 5 sets forth a user interface according to one implementation of the present invention.

FIG. 6 provides a user interface according to another implementation of the present invention.

FIG. 7 is a flow chart diagram illustrating a process flow according to one implementation of the present invention.

FIG. 8 is a functional block diagram showing a network environment in which implementations of the invention may operate.

FIG. 9 is a diagram illustrating a proxy based architecture.

FIG. 10 is a flow chart diagram providing a method, according to one implementation of the invention, executed by a media distribution proxy.

### DESCRIPTION OF PREFERRED EMBODIMENT(S)

The following system described herein is one embodiment of the present invention. In one implementation, the media distribution system includes two main aspects that can be combined or exist independently: 1) a media clearinghouse that connects users and content providers and allows them to search, select content and control where they may view it; and 2) a proxy architecture whereby users may search for websites, or directly request specific websites and, through the proxy based system, view the websites and have media selections intercepted from viewing in a browser and redirected to one or a plurality of devices.

Alternatively, a toolbar type application, or behind the scenes proxy running in the current user environment can operate to intercept digital object types it recognizes—examples being QuickTime or Windows Media files—and rewrite the URL pointing to the media object such that when a user selects the media, the media distribution system determines the media type and other information about the digital object, and provides the user with a choice for transcoding the digital object into a format appropriate for the current user environment and/or to redirect the object or a portion of the object to another environment such as a device capable of receiving the digital object or a transcoded form of the digital object.

Although the reader can appreciate that based on the system here disclosed, other embodiments of the invention using the system facilities can be constructed.

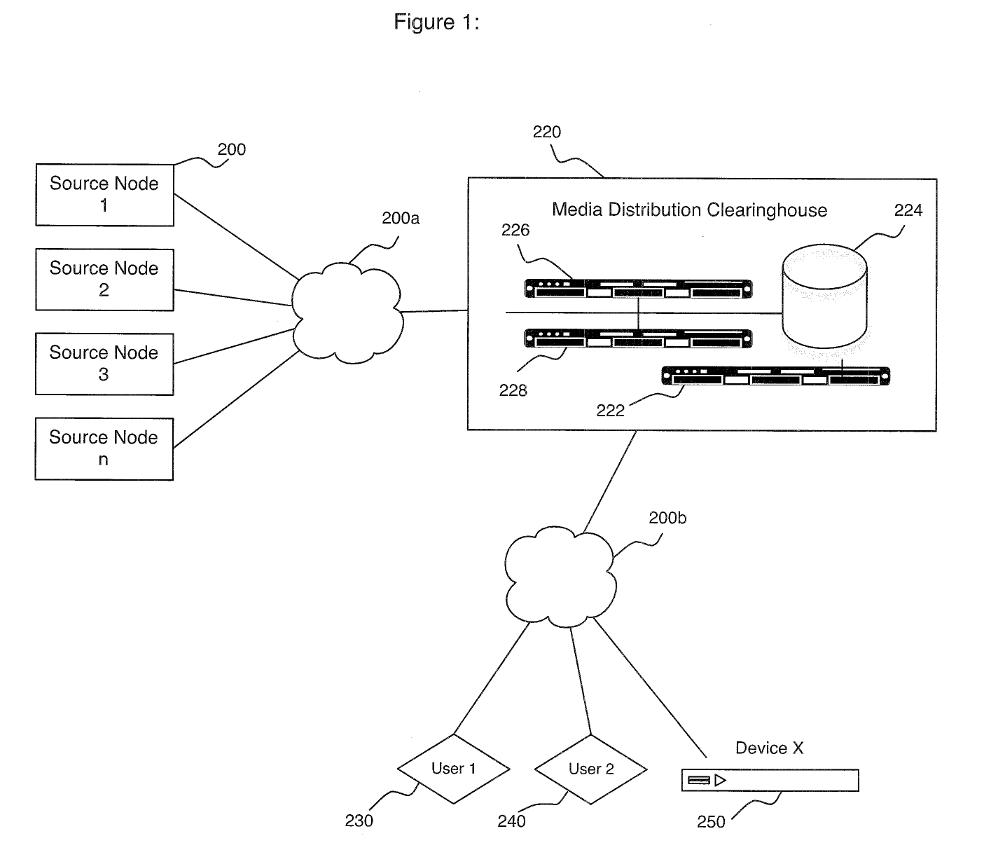

THE CLEARINGHOUSE: Content providers, in one implementation, can publish digital files to the media distribution system, while users can access the system to obtain content. The media distribution system provides a search interface facilitating searches for content. As discussed above, the content can be obtained through one to a plurality of different means, examples include HTML spidering, user published content, copyright holder or distributor published content, RSS, podcast, and so on. A user, FIG. 1, a user 230 accesses the metadata and search facilities 220 though a user interface, typically html or other markup language, which presents a search or browser interface for the user to search for content. Once selected that media may be directed to any one or a plurality of devices 250, according to the media type, user and/or system rules. In one embodiment, a web browser is used to connect to the media distribution system web site. Alternatively a user might, through the use of API's from the media distribution system, access it via any number of suitable devices, whether that be a personal video recorder, client application on a personal computer, PDA, cell phone or any network connected device capable of accessing the API's and thus utilizing the media distribution system. In another possible architecture, the metadata and content storage may be distributed on one or more user computers. In such an architecture, content search and select can take place in a distributed model using a client on the user's computer, as is the art with many of the Peer-to-Peer (P2P) distribution platforms. In this architecture, the P2P system application can apply the user's profile to the media and manage, on behalf of the user, the appropriate download location and encoding.

Referring now to FIG. 1, a block diagram of a network environment in accordance with one or more embodiments will be discussed. A source node 200 serves content that is spidered by the Media Distribution Clearinghouse, 220 or alternatively published by digital object providers. The Clearinghouse 220, in turn, provides one or more of the following: digital object storage, indexing, categorization, transcoding, DRM substitution, and a web proxy. Digital objects are served by source nodes 200 through a network 210a to the media distribution clearinghouse 220. In turn, a user 230 accesses the Media Distribution Clearinghouse 200 via network 210b. In one implementation, media distribution clearinghouse 220 provides a complete search service that proxies the digital objects stored at the source nodes 200. When a user 230 selects an item displayed on the web site of the Media Distribution Clearinghouse 220, the user may then see the web site that serves the selected digital object as they would without clearinghouse 220. In one implementation, the URI's on the page displayed to the user 230 are rewritten such that one or more selected digital objects can be sourced from Clearinghouse 220, where they may be transcoded or reformatted in some manner. A user 240 might directly access published content from the Clearinghouse and a device 250 might receive content directed to it initiated by the Clearinghouse 220. Software operating at the Clearinghouse or at the user's computer or device determines the current responsiveness of the user environment 230 or 240 and alternatively offers a different version of the digital object, either from its cache or by receiving the digital object from 220, transcoding or reformatting the digital object so that it can be appropriate for the environment for user 230, 240 or device 250. The clearinghouse 220 or the system operating at 230 or 240 or 250 may, after determining the responsiveness of the environment or cause the transmission of the selected digital object to another environment that is responsive to the digitial object.

DESCRIPTION OF MULTIMEDIA DATABASE: The media distribution system stores location and metadata about the files which the system has discovered, been directed to, or provided with. The digital objects the metadata refers to might be located on the copyright holders network storage and delivery servers or they might be stored locally or in remote delivery. In the event the media distribution system is instructed to deliver, or if a qualified request is made, any of the servers, and in some embodiments, a plurality of servers delivering pieces of the digital object will deliver the content to a remote device capable of accepting, or requesting and accepting, the files.

Content providers publish content to the media distribution system by registering the meta data concerning the file—such as, media type (QuickTime, Window Media, Real Media or other multi-media container), encoding method (MPEG-2, MP3, AAC, MPEG-4, H-264, WMV, etc), and various other pertinent information such as copyright holder, date, price or price range (for bidding purposes), artist, director, author, description, review, hyperlinks to other sources of information and so on. Alternative methods of obtaining file information through a plurality of different means include RSS (Really Simple Syndication), HTML Spiders of content published on the web or URLs that are provided by users.

The manner of storage for the system can vary widely, as it designed to aggregate databases with potentially different schemas. In a typical embodiment however, the metadata would be stored in an SQL relational database, or an object relational database such as PostgreSQL, or a native XML database such as Berkeley DB XML. All text data from the databases can be offloaded at frequent intervals as XML so as to facilitate indexing and text queries in the manner of the art for text indexing and retrieval.

USER ACCOUNTS—In one implementation, there are at least four types of users in the media distribution system, Super users, Publishers/Merchants, Subscribers, and casual visitors. Casual users have the least amount of privileges and are able to search the content on the media distribution system site but are typically unable to obtain files. Subscribers (users) have the ability to search content, set up profiles of their devices (see below) and of themselves, such as name and address and interests, maintain a list of related users such as family and friends, purchase content to be downloaded to a registered device, and suggest and even upload media content. Publishers (Merchants) have the ability to upload content, set prices, enter metadata about the content including media types, and what types of media to which it may be transcoded, as well as defining digital rights management settings, obtain status and statistical information concerning users, content use, subscriber information and so on. Super users are administrators of the media distribution system and can alter, add or delete data and files, and set up permissions for other users, access billing, payment and merchant data.

The user account system, using, in one implementation, LDAP (Lightweight Directory Access Protocol or other suitable protocol) works with other user account systems such as that provided by the methods promulgated by The Liberty Alliance for single-sign on, although it will appreciated by one skilled in the art that there are many different methods of providing single-sign on. Other sites that participated in using single-sign on would be able to allow users of the media distribution system to easily log into their sites and provide user registration information.

DEVICE REGISTRATION—As discussed above, subscribers may register one or more devices with media distribution system. Device registration, according to one implementation, is of two major types: Device manufacturer's Device information and User device registration. Device specific data is entered into the system that describes the types of devices the media distribution system can access. This sets up the media distribution system to interact with the devices APIs, describe the method of delivery, methods the devices handle and firewalls, i.e. whether device polling is used from the user's device to the media distribution system, and the method of traversing the firewall using methods like ALG, an application layer gateway or UPnP (universal plug and play). Publishers can allow or disallow various devices if they so wish.

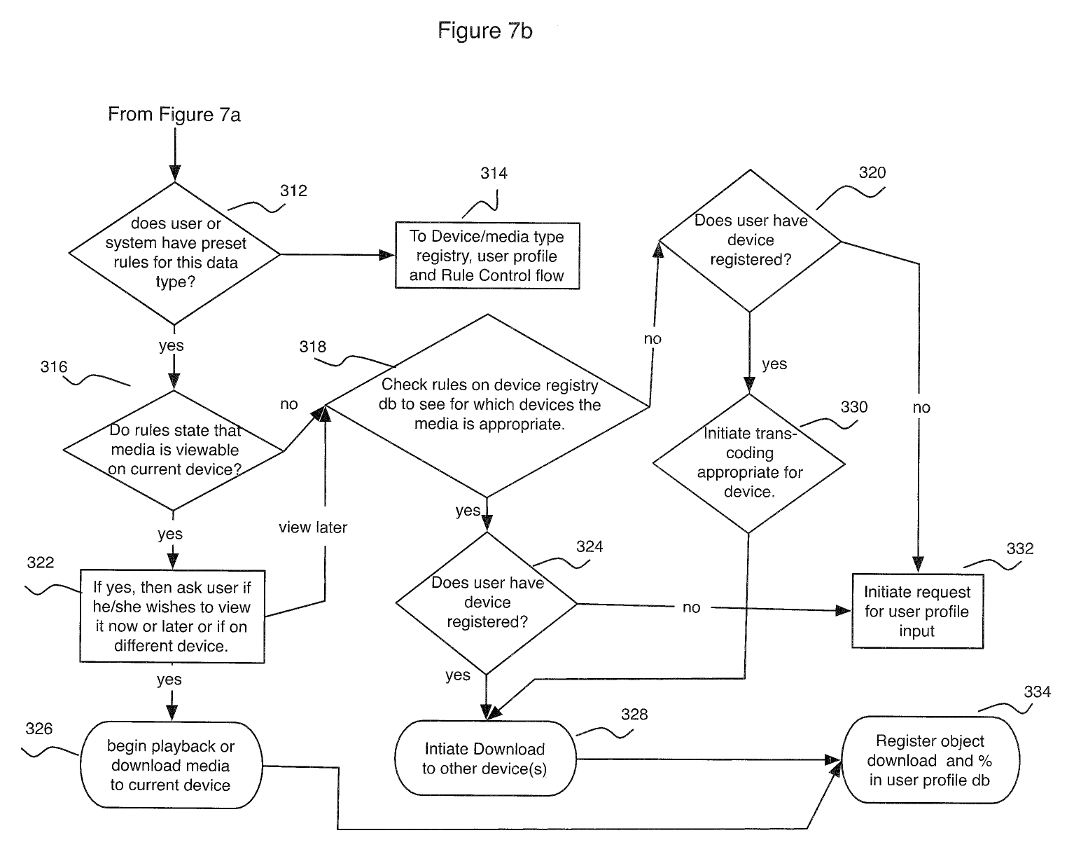

FIG. 8 illustrates a LAN 900 including an array of devices that can be found at a subscriber home or other location, such as a computer 985, personal media player 986 (e.g., iPod), a digital video recorder (DVR) 942 (e.g., TiVo, etc.), a set-top box, and a wireless access point 904 allowing one or more wireless devices (e.g., laptops, PDAs, etc.) to access the network. Typically, a router 902 including network address translation (NAT) firewall functionality operably connects the LAN to the Internet 800 or other network. In one implementation, one or more of the devices behind router 902 includes networking and associated communications functionality to establish connects with media distribution system 100. In one implementation, one or more devices are configured with the IP (network) address and/or domain name of media distribution system. To overcome the device discovery and connection management issues presented by the NAT firewall of router 902, in one implementation, the devices initiate connections (e.g., HTTP connections, FTP connections, etc.) to media distribution system 100 to allow for transmission of programming data and/or media content to the devices. For example, media distribution system 100 can use a connection with a digital video recorder 942 to program it to record a television broadcast. In one implementation, the devices can establish connections with media distribution system and transmit polling or keep-alive messages on an intermittent, on-demand, and/or periodic basis. In one implementation, the devices on the inside of router 902 poll media distribution system 100 at a frequency sufficient to cause the router 902 to maintain the mapping information (e.g., port to inside network address mappings, etc.) needed to route messages transmitted from media distribution system 100 to the respective devices. One skilled in the art will appreciate that there are many possible implementations to maintain port and IP address information to provide connectivity between a system operating behind the firewall and those beyond it. Indeed it is not unlikely that a NAT and firewall will also be used on the server side. Furthermore it is likely that in the future new protocols might be created which do not change the fundamental operation of the system presented here.

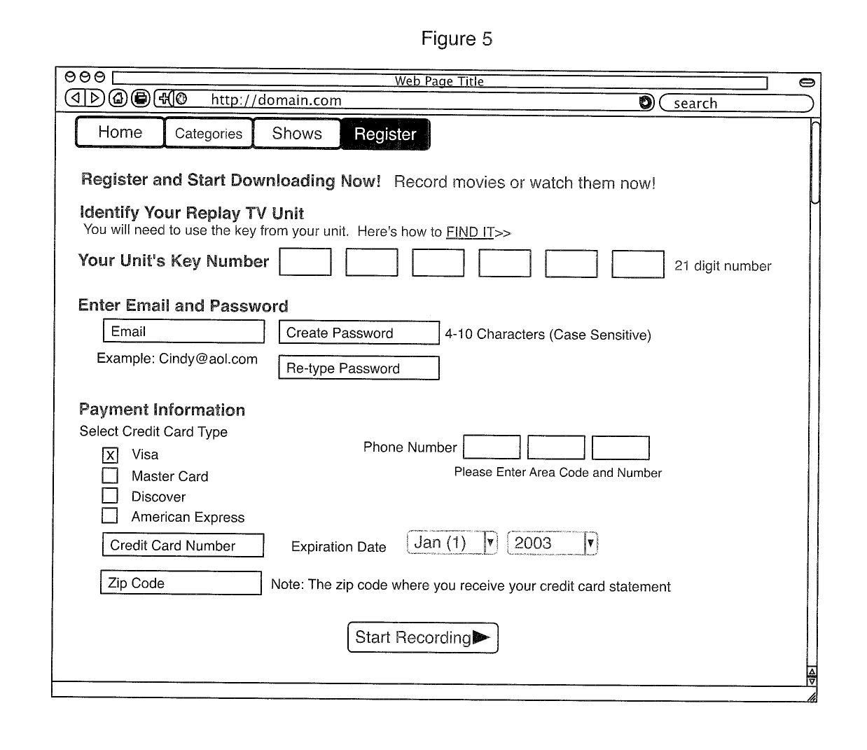

FIG. 5 illustrates a user interface that allows a user to register a device—here, a Digital Video Recorder (DVR). Users may enter device information at any time after they are registered within the media distribution system. This may amount to no information at all, in which case any content selected would be delivered, if appropriate, to the device with which the user accesses the media distribution system—typically this might be a PC, set-top box, or other some other TV accessory, or a built in system within the TV. If the user has chosen to register a device or devices, then he is able to select content for delivery and additionally select or set up rules for delivery to one or more registered devices. Registration information typically consists of the Device type. Once entered, the user is presented with dynamically generated requests for further information based on the device type, such as serial number or ID, IP address, telephone number, other identifying information specific to the device, and possibly device passwords. In some cases, devices may be set up to contact the media distribution system and allow them to register in order to be made ready for accepting digital objects from the media distribution service.

CONTENT DELIVERY—Content delivery can occur under a number of different situations and environments: ‘broadcasts’ (publisher programmed delivery), user selected delivery, rule based delivery, media transcoding prior to delivery, or storing in a remote cache for later delivery. The latter delivery method may be used in cases where multiple users have ordered an object, and a copy is forwarded over high speed Internet connections to a local cache for delivery to a number of clients downstream. In most cases, delivery to a device is determined by a combination of factors: media type, device, and/or whatever rules have been set up by the user or system.

For example, in the case of MPEG-2 encoded content, not all devices can accept MPEG-2. Accordingly, the media distribution system will check to see if the user has a device capable of supporting MPEG-2 encoded content. If the user does, then it might ‘ask’ the user initially if she would like the content of this type delivered to a device which has been previously registered and is known to accept MPEG-2 content. If the user so chooses, (and, in some implementations, if the publisher has allowed it), then the user may choose to have the content delivered to a different device, such as a personal computer, a hand held video device, or any other suitable device. The system then will send an appropriately coded file to the device the user has requested, transcoding the file if necessary. Such transcoding may, in addition to translating between encoding types, also translate between various DRM schemes, if necessary, at the discretion of the system and within the rules (if any) set forth by the publisher.

It will appreciated that there exists a type of digital object that is delivered to users on a regular basis, and typically overwrite a previously delivered or the oldest object, although the user can configure how many past deliveries may be stored at any one time. A publisher, might publish a TV series, news programs or other time dependent or serialized content. The publisher, using Digital Rights Management software, might enable or prevent the storage of previous versions of such serial content if they so desire.

User selected delivery occurs when a user selects content, by whatever method of discovery, to be delivered. Rules set up by the user can automatically instruct the media distribution system to deliver a particular type of content to a particular device in a particular format and DRM method. For example, if the user has chosen video appropriate for widescreen showing, and the user only has one device capable of showing the full resolution, then rules can be set up so that all wide screen content is sent to a device, such as a digital video recorder 942, capable of showing it on their wide-screen TV and not on another device in the user's home which is not so capable.

ARBITRATION: In some cases the same essential content might be available from different publishers; however in one case it might be a ‘panned and scanned’ 4 by 3 ratio format, while from another publisher it may be in High Definition wide screen format. The system, in one implementation, is capable of arbitrating between the various publishers. For example, if a user has registered a cable or satellite provider and a set top box or a different Internet Protocol delivery, then the media distribution system can inform the user that a particular film will be available for recording on the DVR (digital video recorder) or available on demand, and at what price. The user can then have the media distribution system program that device to record or accept the material from the cable or satellite system.

Thus, according to a set of rules by the system and in part controlled by user preferences or input, the media distribution system can arbitrate or provide options according to the best possible source for the download, i.e. from a satellite or cable box or personal video recorder on a different day vs. a download at the time the user is searching for content, or initiating a stream from a cable box or satellite for pay-per-view. The various possibilities for viewing, i.e. download, later recording, or viewing on other system, or immediate viewing are presented to the user for the user to decide his/her next action. Thus a user might see that a film for which he was looking is available via satellite in 2 days, pay-per-view on a cable box within a few hours, or available for immediate download. The media distribution system would then offer the user the various choices for him to decide, or by way of a set of rules, would automatically make such a choice.

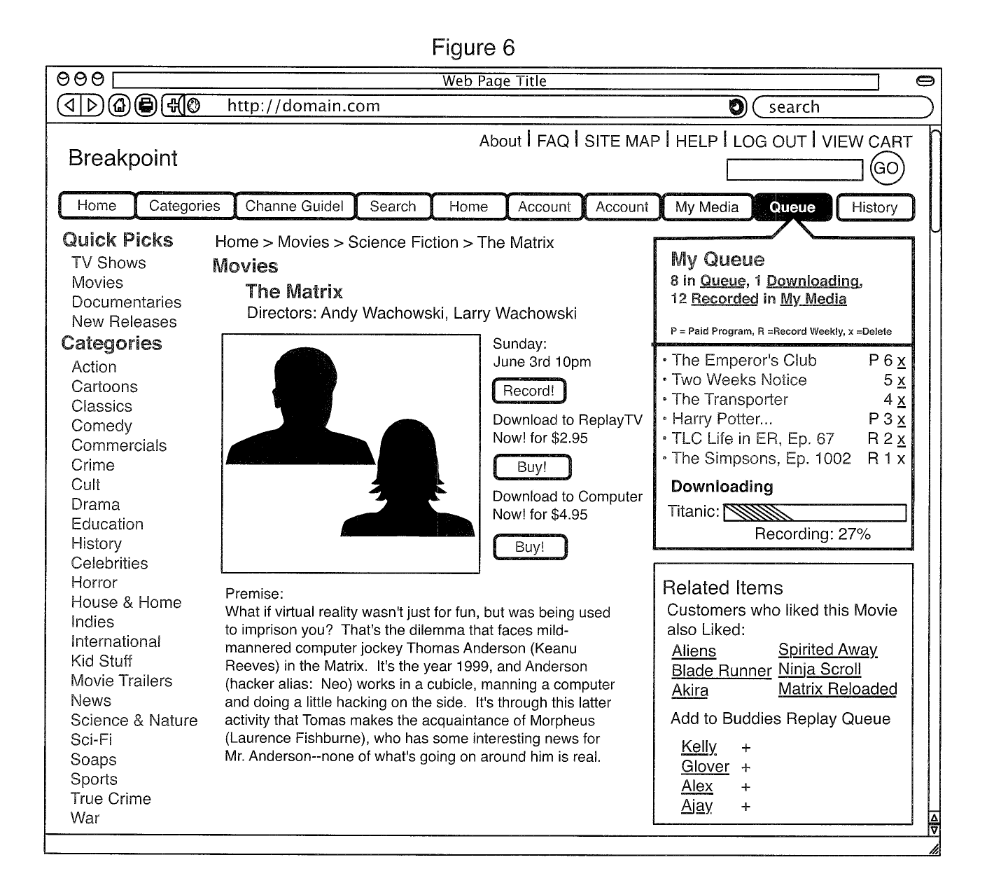

FIG. 6 show a web based interface to the service, here the user has already searched or browsed and selected a particular item, the interface shows a clip of the film, here a trailer and provides the user with the ability to choose between recording it on a personal video recorder (PVR) from a cable or satellite system at a specific time in the future, or that the can purchase it in a format appropriate for a PVR or to the current environment, here a personal computer. The interface also shows a control panel that provide the queue of digital videos that the user has previously chosen and status information (such as, purchased, downloaded and available), the current status of a recording process or download. The control panel may also allow the user to delete the file from this interface rather than using the device's TV based interface. Other features can include a history of previous choices, advanced search, browsing by categories and a means to add a video to a ‘buddies’ PVR. It also in displays related content based on a variety of different criteria.

WEB SERVICES WITH PARTICIPATING WEB SITES: In some cases, companies might choose to utilize a web services type architecture with the media distribution system infrastructure, allowing a user who browses to a website the ability to have content downloaded directly to the appropriate device rather than watching it as he or she browses. In this situation, the participating website has accepted the web service APIs from the media distribution system, which includes the ability for the user to be recognized as a registered user. Typically this can be done by having the website host a sign-on server which is in both its own domain and a domain hosted by the media distribution system. A server for participating web site foo.com would for the media distribution system bar.com also have a domain alias controlled by bar.com such as foo.bar.com. Because the root domain is the same, the server foo.com can also read cookies in the domain bar.com This allows the participating website to read cookies from the user's browser that were set by the media distribution system. Thus, the participating web site's system can recognize the user as a media distribution system registrant. In this case, the web site can dynamically present the user with the choice of using the media distribution system to handle content in the appropriate manner.

OPERATION OF CLEARINGHOUSE: Both Content Providers and Content Receivers such as video devices that connect to the TV, as well as Media PCs, will be able to utilize the ASP side of the media distribution system infrastructure. This part of the infrastructure surfaces the ability to remotely program the user's receiver or other device from the media distribution system site. The system shares personalization information directly from the content owners own personalization infrastructure, or uses the registration info the user provided during signup to the media distribution service.

A browser plug-in or a web proxy provides a means for the media distribution system to keep track and, if necessary, rewrite URI's when a user is browsing any website with content. A user can go directly to the media distribution system to search the entire web for digital content. When the user clicks on a link that is a recognized digital object, the media distribution system will recognize that and offer, either on the page directly or in a pop-up menu the option of watching it online, or having it automatically downloaded to a cache at the media distribution system site and transcoded to the proper format for which ever device the user chooses, such an action may happen prior to the user selecting any media related URI's on the page, or instead at the moment the user clicks on a hyperlink.

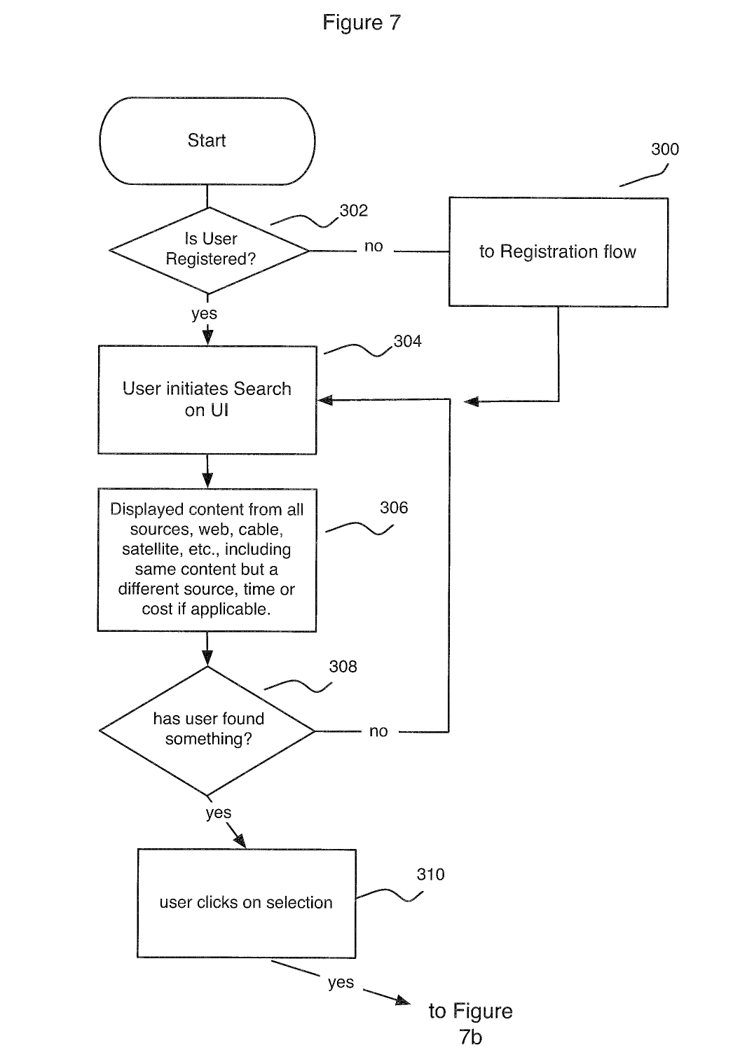

FIG. 7 is a flow chart illustrating how the media distribution system 300 allows a user to initiate a search 302 for media on a user interface, in either a conventional search query input field or by browsing through a directory. If the media distribution system does not see a cookie (with a web browser) or other data indicating that the user has registered with the system, then the user is directed to a registration flow (not pictured here) which will allow the user to register various profile information about himself, including credit card or other means of allowing purchases to take place if necessary. As discussed above, the registration system also allows the user to register various devices with the system, such as a media player, personal computer, personal video playback device, etc. Typically, this registration will entail the user providing a registration ID for a device that typically includes a serial number of the device and other appropriate information for the media distribution system to contact and deliver content.

If the user is registered, media distribution system allows the user to search for content 304. In one embodiment, the media distribution system will have indexed content that has either been published into the media distribution system by owners or intermediates of content, or has been discovered by conventional spidering and gathering of URLs of media content. In another embodiment, the media distribution system will effectuate proxy based browsing, where the user can search throughout the web.

In one implementation, all content that is passed on to the user comes through the media distribution system's http proxy, which modifies the URLs of recognized media content (such as QuickTime files or MP3 files) in web pages displayed to the user to point to a specialized URL on the media distribution system. When a user selects a URL in the browser, the request is transmitted to the media distribution system (310).

In the case where the user is searching on the general system (and not through a proxy based browsing system), the user, after initiating a search 304, may see textual and graphic content 306 giving the user a variety of media to choose from. In addition to material that is already stored in one or more network resources for download, the media distribution system can also use the user's zip code contained in the user's profile and their cable or satellite or local broadcast information in order to check if the media for which the user is searching is also available through conventional broadcast, or streaming by a cable or satellite system. If there is such media available over these other channels, then the media distribution system may provide such information and display it optionally with the data about the downloadable files. This is to provide the user with the knowledge that he or she might obtain the media object from other sources. Given preset rules, the media distribution system may then display data about broadcast information if the user has configured one or more applicable rules and if the media falls within the applications of those rules.

After the search (308), the User Interface will present with the choice of searching again if the user is not satisfied with the results of the first search. The user then will make a selection of a media object 310 and the media distribution system will check 312 if the user or system has preset rules for that data type. If not then the user is directed at 314 to obtain additional user profile, device profile information or media type information appropriate to the content the user chose.

If the system determines 312 that a device and rules for the data type in question exists, the system then determines 316 whether the device the user currently is on is one such device that the user might view the content on. If no, at 318 the media distribution system checks against the registered devices in a database, and determines the appropriate devices where the media might be downloaded, transcoded and/or played on. If a device appropriate for the system is discovered, then the system checks at 320 whether the user has such a device registered. If the user has such a device, and the media object is not in a format that appropriate devices can use, then the media object is transcoded into a compatible format at 330 and a download to the appropriate device is initiated 328. As the download progresses, the media distribution system keeps track of how much has been downloaded at any one time and that data is made available in real time to the user if he is still browsing the web site.

If at 316, the user is currently using a device where the media object can be played, which would be typical in the case where the user is browsing through a proxy browser, then at 326 the media distribution system will either pass the media from it's original source on to the user or it will provide the media from it's own cache. Typically, this would be while the user is in a browser on a web page on a personal computer, however it might also be true for users browsing on other devices which through the system's Application Programmer's Interface (API) the content is made available, as in an internet connected set-top box for the user's television. Once playback or download is initiated 326, then the percentage downloaded information is sent 334 to the system. [See FIG. 6]

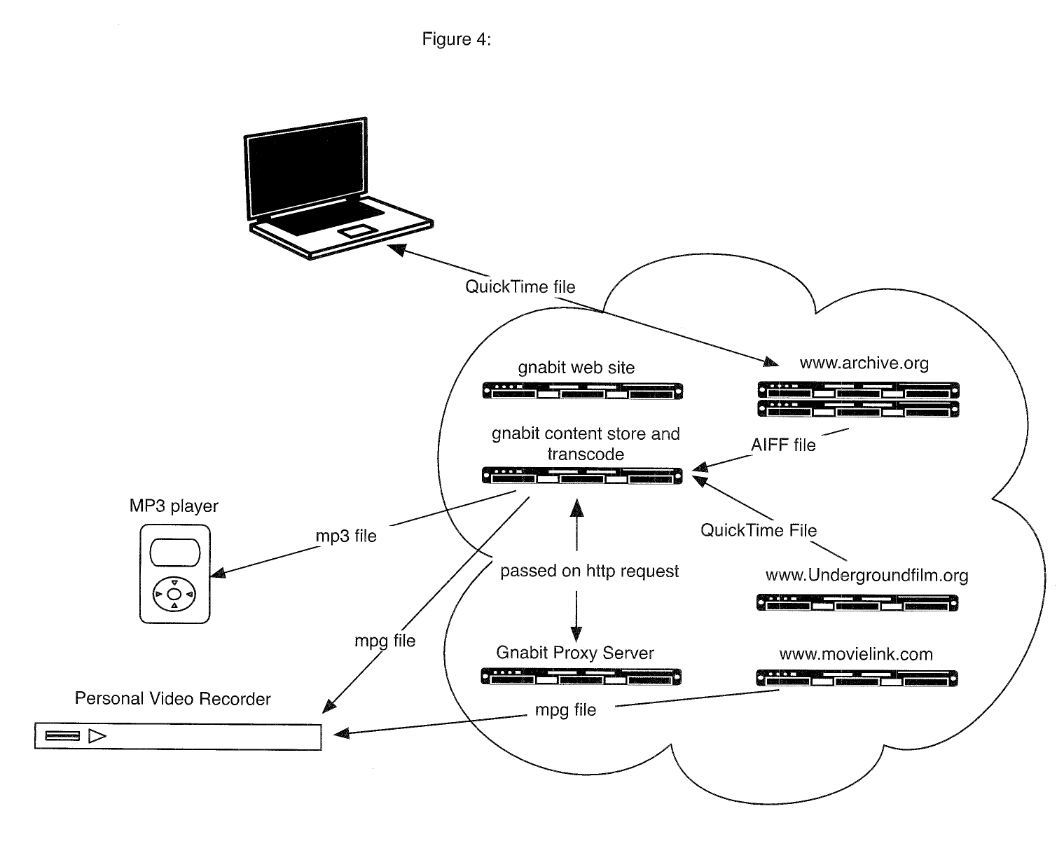

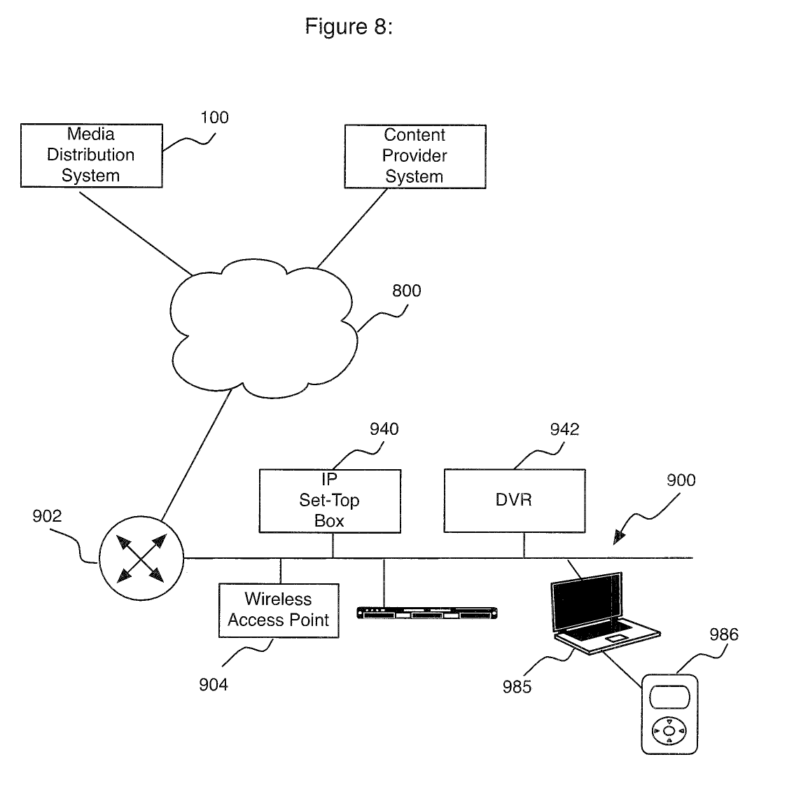

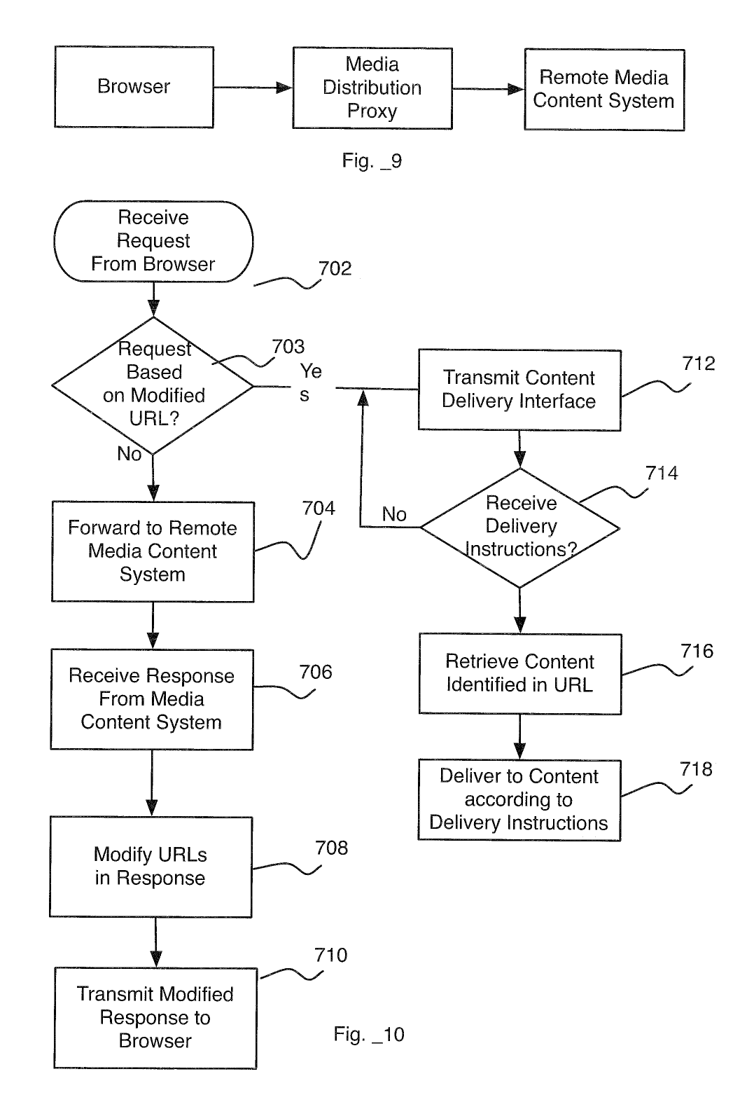

THE PROXY/PLUG-IN ARCHITECTURE: The proxy architecture allows a user to search for websites, or directly request specific websites and, through the proxy based system, view the websites and have media selections intercepted from viewing in a browser and redirected to one or a plurality of devices. FIGS. 4 and 9 shows that the proxy intervenes between the user's browser and any one of a number of other web sites or systems providing access to content. FIG. 10 illustrates operation of the proxy according to one possible implementation of the invention. In one implementation, a web browser is used to connect to the media distribution web site. The media distribution system provides a search interface of content the system has obtained metadata for from a plurality of different means such as HTML spidering, published content, RSS, etc. Similar to the Clearinghouse model, here the Proxy Based system also allows the user to browse to the website where the content is originally provided, and see the web page of the remote site, in real time. However, the web page provided to the user's browser has been obtained and modified by a proxy of the media distribution system (see FIGS. 10, 702, 703 704, 706, 708 and 710). In one implementation, the media distribution system recodes the html of a web page such that one or more URI's embedded in the page now point to the media distribution system web site. Thus , where foobar represents the domain name of the service, http/gridfarm1.undergroundfilm.org/media/september1999/1001452_lar.mov represents a QuickTime digital video on the website Undergroundfilm.org, the URI would be rewritten to: http://www.foobar.com/useraccount/environmenttype=ReplayTV/filetranscode=mpg2/http://gridfarm1.undergroundfilm.org/media/september1999/1001452_lar.mov. Thus, when a user selects a hyperlink which represents a media type (FIG. 10, 703), the media distribution system, in one implementation, presents a content delivery interface (712) allowing the user to configure one or more content delivery options (e.g., target device, format, etc.), and redirects the request through the system such that the file is downloaded to the media distribution system infrastructure (716, 718) and is transcoded (see FIG. 10, 718) if needed to an appropriate format, file type, or bit rate, and redirected to the appropriate device, here a ReplayTV personal video recorder with MPEG-2 encoding, additionally it might also transcode a version and make it available in a different format for the user's current environment, and convert it to an appropriate MPEG-4 format and file type so that when the user downloads the file to their PC, it can be loaded into their iTunes player and then synchronized to their video capable iPod. Such a system would work not only for digital video but also any suitable file type, such as MPEG-3, or even an application or video game.

SYSTEM ARCHITECTURE DESCRIPTION: The media distribution system, in one implementation, comprises the following: a proxy web server and dynamic page generation system which rewrites the URLs of a web page. A redirection content server which can act on behalf of the user and initiates a download to store the content on the system's content server rather than having the content downloaded to the browser and device currently being used. A transcoding system which can transcode the content from one format into the appropriate format for the device the user or system has set for later play. A listening application that waits for the device to poll for new content. A database to store user content, history, allow sign-on and registration of user information and device information, including network location if appropriate. A set of API's allowing device manufacturers to interface with the media distribution system and a means of interfacing with various device's API's in order to contact, control, download and delete content from the device.

As an alternative to the proxy web server, a browser plug-in can be configured so as to send html from a site the user is on back to the media distribution system or be configured to recognize html from the page and rewrite the URL's as in the above proxy web site system.

BASIC OPERATION OF PROXY: In one embodiment, the system of the present invention allows users to configure a variety of content delivery options for content located on networked resources. A proxy web server rewrites the URLs and adds HTML or scripts to allow the user to initiate a redirection of the content to one of their registered devices appropriate for the content.

For example, when a web surfer finds content on a web server he wishes to view, rather than being forced to view it immediately on the device where he found it, the system of the invention allows the user to specify delivery of the content to an alternate device for viewing. Any network connected and network addressable device capable of storing a file might be configured to store the download either for viewing on the self same device or via another network connected device capable of addressing the device storing the file. Typically, this would be a personal computer configured to accept a remote file transfer from which a user might play it directly on that computer, or transferred over a network to a network addressable device capable of playing the content in such a way as to play it on a home stereo system, a television, or any device capable of playing the file.

In one of the embodiments, the present invention is typically viewed via a website whose database contains a set of metadata which describes aspects of multi-media content, the database further contains the location or locations where it is stored. The multi-media objects might be located at another website, a copyright holder's servers, third party caching servers or on the media distribution system's servers or from a user's own home network, such as from a personal computer, or a network connected personal video server or other server capable of being addressed remotely. Media content might also be available on portable handheld-networked devices such as PDAs, cellular phone or any device capable of storing a file and delivering it over a network.

OPERATION OF PLUG-IN: The plug-in effectively modifies the browser to send page HTML and scripts to the media distribution system for processing and URL rewriting. One difference between the plug-in and the proxy architecture is that the user need not first browse to the media distribution system in order for the system to begin proxying.

API'S FOR REMOTE SYSTEMS CONTROL: One aspect of the system provides a set of API's (Application Programmer Interfaces) to allow digital multi-media providers to provide a link (such as a button, or hyperlink) on their websites or other interface, such as a display on a cable box, Personal Video Recorder, application on Personal Computer, PDA, portable phone or any device which can display information concerning a media object. In the event that a user has conventionally ‘surfed’ to such a site over the web and selects such a link, rather than the media being presented to the user directly, a server request is made to see if the user has a unique cookie in the browser that identifies the user as being a subscriber or user of the media distribution system. If they are so identified, then the server makes a call to the media distribution user profile system. The website then obtains the appropriate information to display through the website's User Interface a request as to whether the user would prefer to play the content on the current device or from a list of optional devices registered to the user which the media distribution system has determined are appropriate for the content. By way of example, this allows a user to choose whether he would prefer to watch the video he had selected on his TV later that night, rather than watching it on the personal computer he found it with. In the event the user so chooses, then a version of the file would be downloaded to the user's personal video server, or personal computer so set up to receive content from the media distribution system, as determined by another aspect of the present invention.

One aspect of implementations of the media distribution system also provides a single-sign on system and proxy ‘surfing’ method which allows a user to log in to the platform over the web or any hypertext interface and view content on web sites or any hypertext system through the platform. This is in contrast to the part of the system that provides for search on metadata that resides on the database that is published to it. Data may be published manually or via a web services type interface, or RSS http spider which periodically updates the metadata in the database. In the case of RSS with enclosures, the media file would be downloaded to media distribution system content servers or a content delivery network. Alternatively, the media distribution system simply maintains the URI (Universal Resource Indicator) of the content to point the users to so that they may download it directly from the source to selected devices.

The platform then recognizes appropriate multi-media content and provides the option via buttons, pop-up menus, or side-bar controls to redirect the object to any appropriate device, as outlined above. The system furthermore maintains a user controllable set of rules which facilitates the redirection of the multi-media object to the appropriate device or set of devices.

The media distribution system, in one implementation, also keeps a record of the user downloads and purchases, bookmarks, shared bookmarks and other information concerning the multi-media objects the system has handled on behalf of the user.

In the case of a cable box, satellite or other broadcast or streamed delivery system the program guide information for such a time-based content delivery system is searched while a user searches within the content index hosted by the media distribution system, such that the system can provide information that the user may purchase or otherwise obtain the media object from any number of other content delivery systems. According to a set of rules by the system and, optionally, controlled by user preferences or input, the system can arbitrate or provide options according to the best possible source for the download, e.g., from a satellite or cable box or personal video recorder on a different day vs. a download at the time the user is searching for said content, or initiating a stream from a cable box or satellite for pay-per-view. The various possibilities for viewing, e.g., download, later recording, or viewing on other system, or immediate viewing are presented to the user for the user to decide his/her next action. Thus a user might see that the film for which he was looking is available via satellite in 2 days, pay-per-view on their cable box within a few hours, or available for immediate download. The media distribution system might then offer the user the various choices for them to decide, or by way of a set of rules, it might automatically make such a choice.

In the one embodiment, either by use of proxy web server or browser plug-in, a hyperlink to a media file such as a QuickTime video, is detected and modified as a user is browsing a web site to point to one of the media distribution system servers. When the page is rendered in the user's browser, the hyperlink is modified in such a way as to include a hash value which identifies the user (although this could be done with a cookie at the time of the user clicking on the hyperlink). When the user clicks on the hyperlink which refers to the original media file accessed through the web page, the user is presented with a pop up window, another web page, or a window initiated by the toolbar to give the user the choice of proceeding normally and watching the video in the manner the site would have provided initially, or redirecting the video to the media distribution system server for the purposes of either watching it later by directly accessing a cache at the media distribution system server, or to ‘device shift’ so that the user might watch the video later on another network connected device or on a tape or DVD sent to the user by physical mail.

In this embodiment, a download is initiated from the media distribution system server rather than the user's machine and the file is cached at the media distribution system server. If the secondary device requires a different encoding format, then the media distribution system server initiates a ‘Transcode’ of the file to the appropriate encoding format and the file is scheduled for delivery to the user's intended secondary device. It should be noted that in this embodiment, the device might be another PC, a so-called DVR (Digital Video Recorder) an example of which is the ReplayTV device, or the Akimbo box.

Service Description

In one implementation, the media distribution system serves as the clearinghouse through which syndicated content flows from any source to any device. Specific devices likely to be used are: Personal TV devices like Replay or TiVo, PC to small footprint device like Prismiq or PS-2+Broadq, broadband caching devices within TVs, local broadband exchanges with caching, personal computers, hand held devices like the Handspring, and video equipped cellular telephones. The data can be ‘moved’ to say a person's hotel room, a different PC or a different household or even shared with others by virtue of a ubiquitous personalization system.

The user will interact with the system either through the media distribution system web site, or through ‘syndicated’ methods of embedding the interface within any TV or Film listing page on the web. The media distribution system infrastructure can expose an API to enable any web site to participate in a variety of degrees and manners. Thus one possible application for media distribution system is to provide a service for TV related electronic program guide type information—the infrastructure allows a user at a participating web site to pick from the Guide the content she wishes to record for devices which can record from broadcast, streamed cable or satellite boxes like TiVo or ReplayTV or download to internet connected video devices such as Akimbo. The system is capable of keeping track of the content on the remote device and can thus inform the user from the media distribution system website as to what has been downloaded onto what device, and in the case of download which is yet unfinished, the user can view the percent downloaded. If there are new instructions from the media distribution system infrastructure, the appropriate device will poll regularly and thus be informed of changes. Typically, because most devices are behind user's home firewalls, devices need to poll a service because The device will need to be directed to the server either by configuring it on the device, or if it has a server it normally talks to, as many such devices do, it might obtain the domain name of the media service from the same server it normally uses own, for example the server that services information for your TiVo or ReplayTV. In the case of an iPod type device connected to your PC, an application on the PC would establish the connection to the media service and then handle the forwarding of the data.

Alternatively there are new protocols which have been designed to handle device discovery, such as ‘ALG’ Application Layer Gateway or UPnP (Universal plug and play) which enable a device to obtain and maintain a specific port through a gateway or router. Once a port number is established that is unique, the router can forward IP packets directly to a service listening on the device. If there is new content, then that file is uploaded to an appropriate device or media distribution system managed directory on the PC. Thus the media object or objects are available on demand when the viewer returns home or whenever the system has delivered the object.

The media distribution system infrastructure, because it is accessible as an API, enables sites that have their own content to place a media distribution button (or other interface control) next to the content. The content will flow to the user via the Internet to a device that can accept it, or it can instruct a device to record from video streams that a service provides and remotely authenticated via the media distribution system infrastructure.

The media distribution system service provides, in the Guide or search area the ability for the user to see that their cable or satellite service might be offering the same desired material, the user is presented with the option of scheduling a recording or ‘buying’ the download.

A user might see a teaser video or trailer from a content provider placed anywhere on the web, next to or right in the frame of the clip the user can nab it, and with one click have the full movie scheduled to be cached at their appropriate head-end, be that a Replay box, Tivo, SonyPlaystation, or any such device which can accept a media file and ‘play’ it. Concomitant with selecting the film, a custom trailer might also be appended to the film, for advertising purposes, merchandise etc. At the time the user selects the film, he might also be presented with appropriate merchandising opportunities.

EXEMPLARY USER SCENARIO: A surfer comes across a news clip on a website. He watches the news clip through in a QuickTime format and wishes to see the full video version (or the rest of the story or related stories) later when he gets home. He can select the video and have it sent to a local cache to be seen later—customized advertising, merchandising might be appended to the video based on a combination of user profile and source profile (i.e. NPR, CNN, etc).

A user comes to the media distribution system web site to schedule a recording of the next presidential debate on his ReplayTV, unfortunately he has just missed the broadcast, luckily when the user searches on the media distribution system site, it can inform him that it is available for download and can be either watched immediately on his PC or can be delivered to an Akimbo box at home or at homemade MythTV unit at their weekend home, all of which have been previously registered with the media distribution system service. He is presented with a pop up menu of places to which to send the video.

In an account on the media distribution system, each video, as well as related content and context, is stored in an automatically created and maintained ‘video Blog that represents the user's download history. The user can share this video Blog with his friends, email specific items, and be notified when similar videos appear on the web. The latter function is accomplished by an agent which learns the user's category interests and automatically finds related content, first in his friend's video Blogs, then friends of friends and finally within the overall search domain of the media distribution system. Friends and even the public, if the user so allows, can subscribe to the video Blog. Video Blogs are themselves items to discoverable through the media distribution system search interface.

Lastly, the present invention has been described with reference to specific embodiments. Other embodiments of the present invention will be apparent to one of ordinary skill in the art. It is, therefore, intended that the scope of the invention not be limited to the embodiments described above.

What is claimed is:

1. A computer implemented method implemented between a remote computing system and a web browser located on a user's device comprising:
receiving from a client's device at the remote computing system a user login and password information and storing said information in a database;
receiving from a client's device information pertaining to a user created information relating to a media object and storing said information in a second database;
receiving a search query containing key words or category information from said user or one or a plurality of other users and if there is a match of the keyword or category information on the user created information stored in said second database causing said user created information to be displayed on said one or a plurality of users' devices;
providing, a reference to the media object from said database or proxy of said database from said remote computing system that one or more environments that has been previously registered can access to said media object for play, stream or download.

2. The computer implemented method of claim 1, the method further comprising:
receiving from the user at one or more of said environments an indication to play, stream or download or transfer the rights to said media object.

3. The computer implemented method of claim 1, the method further comprising:
causing the media object to play, stream, download or transfer the rights from a server or proxy or content delivery network.

4. The computer implemented method of claim 1, the method further comprising:
providing, a reference to the media object from said database or proxy of said database from said remote computing system that one or more environments has been registered and can access to said media object for play, stream or download.

5. The computer implemented method of claim 1, the method further comprising:
receiving from the user at one or more of said environments an indication to play, stream or download or transfer the rights to said media object.

6. The computer implemented method of claim 1, the method further comprising:
causing the media object to play, stream, download or transfer the rights from a server or proxy or content delivery network.

7. The computer implemented method of claim 1, the method further comprising:
displaying in a second area of the display on said device a series of URI's that point to a remote server for obtaining the media object display in the second area of display.
